(19) United States
(12) Patent Application Publication
(10) Pub. No.: US 2026/0308983 A1
(43) Pub. Date: Oct. 8, 2026

(54) HIGH VOLTAGE ELECTRO PULSE ROCK DRILLING

(71) Applicant: EPIROC ROCK DRILLS AKTIEBOLAG, Örebro (SE)

(72) Inventors: Erik JAKOBSSON, Örebro (SE); Harald Franz Arno MERKEL, Örebro (SE); André SKYTTEDAL, Örebro (SE)

(21) Appl. No.: 19/482,437

(22) PCT Filed: May 9, 2023
(86) PCT No.: PCT/SE2023/050450

§ 371 Date: Nov. 7, 2025

(51) Int. Cl. E21B 7/15

(52) U.S. Cl. CPC E21B 7/15

(57) ABSTRACT

A drilling arrangement for high voltage electro pulse rock drilling, the drilling arrangement including a pulsed power generator for generating high voltage electro pulses; a drill tool for forming a drill hole by conveying the generated high voltage electro pulses, via electrodes in the drill tool, through mineral substrate; at least one switch, arranged between the pulsed power generator and the electrodes, which switch when it is closed allows high voltage electro pulses from the pulsed power generator to reach the electrodes; and a switch control device. The switch is preferably a controllable switch including a switch closing arrangement, which is controlled by receiving a switch trigger signal emitted from the switch control device to close the switch. The switch control device is preferably arranged to synchronize the switch trigger signal with the high voltage electro pulses from the pulsed power generator.

### TECHNICAL FIELD

The present disclosure relates generally to arrangements and methods for high voltage electro pulse rock drilling by passing a pulsed electrical current through a mineral substrate. The disclosed arrangements and methods may for example be applied in rock drilling, concrete processing, mineral processing, and continuous mining.

### BACKGROUND

In the field of rock drilling, a new technology has emerged during the recent years, referred to as electro pulse boring (EPB), plasma channel drilling, pulsed plasma drilling, etc. The technology relies on mechanical electrodes creating contact with a rock material, and the application of a high voltage between the electrodes. The discharge occurring, if successful, penetrates the rock material and breaks loose small pieces.

### PROBLEMS WITH THE PRIOR ART

When charging a pulse generator connected to electrodes in a conducting media, such as water, it is necessary to limit the parasitic discharge through the media between the electrodes.

There is thus a need for improved arrangements and methods for high voltage electro pulse rock drilling.

### SUMMARY

The above-described problem is addressed by the claimed drilling arrangement and method for high voltage electro pulse rock drilling.

The drilling arrangement preferably comprises: a pulsed power generator for generating high voltage electro pulses; a drill tool for forming a drill hole by conveying the generated high voltage electro pulses, via electrodes in the drill tool, through mineral substrate such as rock material; a switch, arranged between the pulsed power generator and the electrodes, wherein the switch when it is closed allows high voltage electro pulses from the pulsed power generator to reach the electrodes; and a switch control device. The switch is preferably a controllable switch comprising a switch closing arrangement, which is controlled by receiving a switch trigger signal emitted from the switch control device to close the switch.

The method for high voltage electro pulse rock drilling may be performed using a drilling arrangement comprising a pulsed power generator, a drill tool comprising electrodes, and a controllable switch, arranged between the pulsed power generator and the electrodes, wherein the switch when it is closed allows high voltage electro pulses from the pulsed power generator to reach the electrodes. The method may comprise: generating high voltage electro pulses, using the pulsed power generator; forming a drill hole by conveying the generated high voltage electro pulses, via the electrodes, through mineral substrate such as rock material; and controlling a switch closing arrangement to close the controllable switch. The switch closing arrangement is preferably controlled by: receiving a switch trigger signal emitted from a switch control device; and closing the controllable switch based on the switch trigger signal.

The claimed arrangement and method enable the achieving of a limitation of the parasitic discharge for the pulsed power generator, by allowing the pulsed power generator to not always be connected to the electrodes.

In embodiments, the pulsed power generator comprises a pulse transformer in the form of a bank of capacitors, and is arranged to generate a high voltage electro pulse each time the switch is closed. This is an efficient way of achieving a limitation of the parasitic discharge for the pulsed power generator, by allowing the pulsed power generator to not be connected to the electrodes during charging of the bank of capacitors.

In embodiments, the pulsed power generator is arranged to continuously generate high voltage electro pulses, and the switch control device is arranged to synchronize the switch trigger signal with the high voltage electro pulses from the pulsed power generator. This ensures that the high voltage electro pulses generated by the pulsed power generator are conveyed to the electrodes with an optimal pulse shape.

In embodiments, the switch control device is controlled to emit a switch trigger signal for each high voltage electro pulse generated by the pulsed power generator.

In embodiments, the switch control device is controlled to emit the switch trigger signal with a fixed timing in relation to the high voltage electro pulse generated by the pulsed power generator.

In embodiments, the switch control device is arranged to synchronize the switch trigger signal with the high voltage electro pulses from the pulsed power generator by using the switch trigger signal also for triggering the pulses from the pulsed power generator. This is a simple way of synchronizing the switch trigger signal with the high voltage electro pulses from the pulsed power generator, which may e.g., be effected using a common control unit.

In embodiments, the switch comprises a spark gap filled with a switch gas between switch electrodes, and the switch closing arrangement causes the ionization of the switch gas and thereby the closing of the switch. This is a reliable way of arranging a switch, compared to mechanical solutions, which may be unreliable at high voltages.

In embodiments, the switch closing arrangement comprises a light emitting device, which causes the ionization of the switch gas by emitting light into the switch gas. This is a simple switch closing arrangement that still allows an exact control of the closing of the switch, since the light emitting device may be galvanically separated from the switch electrodes.

In embodiments, the switch closing arrangement comprises a radioactive source, which causes the ionization of the switch gas by emitting radioactive radiation into the switch gas. Such an embodiment of the switch closing arrangement allows an exact control of the closing of the switch, since the radioactive source may be galvanically separated from the switch electrodes.

In embodiments, the switch closing arrangement comprises an ignition electrode, arranged so that there is an ignition spark gap between the ignition electrode and one of the switch electrodes, where the ignition spark gap is much smaller than the spark gap between the switch electrodes, and the ionization of the switch gas is caused by a voltage being applied to the ignition electrode, causing the ignition spark gap to break down. This causes the electrons and ions generated in the ignition spark gap to migrate into the main spark gap, where they will accelerate due to the large electric field in the main spark gap, cause avalanche ionization of the switch gas in the pressurized volume, and thereby cause the main spark gap between the first and second switch electrodes to break down. This allows for a very exact control of the closing of the switch, since the voltage required for ignition is low enough to be handled by common solid state components, such as e.g., thyristors.

In embodiments, the drilling arrangement comprises more than one switch, such as e.g., two switches. This enables the disconnection of both electrodes from the pulsed power generator.

The above described problem is further addressed by the claimed use of the above drilling arrangement for breaking a mineral substrate, such as in any one of rock drilling, concrete processing, mineral processing, and continuous mining.

The above described problem is also addressed by the claimed rock drilling machine, comprising the above drilling arrangement.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 schematically illustrates an embodiment of a drilling arrangement for high voltage electro pulse rock drilling, in accordance with one or more embodiments described herein.

FIG. 2 schematically illustrates a rock drilling machine, in accordance with one or more embodiments described herein.

FIGS. 3a and 3b schematically illustrate embodiments of a controllable switch for use in a drilling arrangement for high voltage electro pulse rock drilling, in accordance with one or more embodiments described herein.

FIG. 4 schematically illustrates a method for high voltage electro pulse rock drilling, in accordance with one or more embodiments described herein.

Embodiments of the present disclosure and their advantages are best understood by referring to the detailed description that follows. It should be appreciated that like reference numerals are used to identify like elements illustrated in one or more of the figures.

### DETAILED DESCRIPTION OF EXAMPLE EMBODIMENTS OF THE DISCLOSURE

The present disclosure relates generally to arrangements and methods for high voltage electro pulse rock drilling by passing a pulsed electrical current through a mineral substrate. Embodiments of the disclosed solution are presented in more detail in connection with the figures.

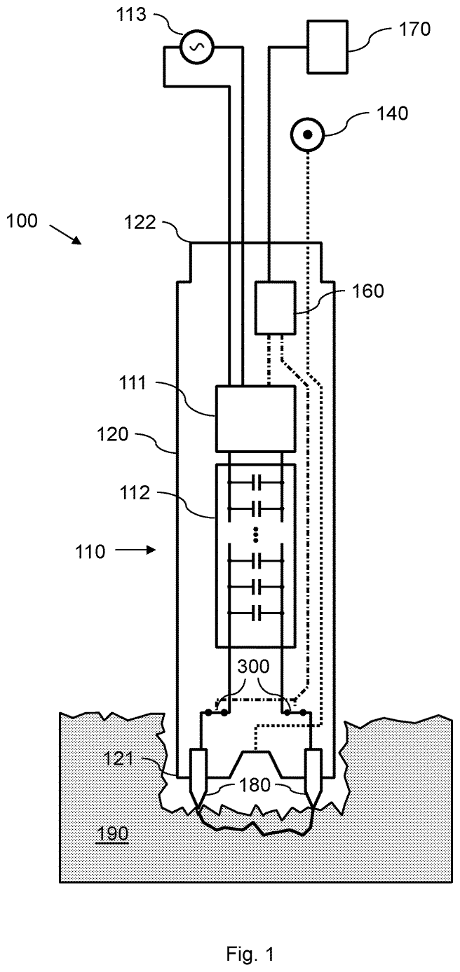

FIG. 1 schematically illustrates an embodiment of a drilling arrangement 100 for high voltage electro pulse rock drilling. The drilling arrangement 100 schematically illustrated in FIG. 1 comprises a pulsed power generator 110 for generating high voltage electro pulses, and a drill tool 120 extending in an axial direction of the drilling arrangement 100 between a front end 121, configured to be positioned near or at a surface of a mineral substrate 190, and a rear end 122. A pair of electrodes 180 are arranged at the front end 121 of the drill tool 120, protruding slightly therefrom. Each of the electrodes 180 may comprise a solid electrode portion with a conductive casing, so that a high voltage electro pulse generated by the pulsed power generator 110 passes through the casing and to the solid electrode portion, where a discharge is formed between the solid electrode portion and the mineral substrate 190. The high voltage electro pulse may thus pass between the solid electrode portion of the first electrode and the solid electrode portion of the second electrode via the mineral substrate 190, forming a plasma channel in the mineral substrate 190, with the result that the mineral substrate 190 is broken. The drilling arrangement 100 schematically illustrated in FIG. 1 further comprises a fluid supply system 140, which may be used for supplying a shielding fluid to a region between the drill tool 120 and the mineral substrate 190.

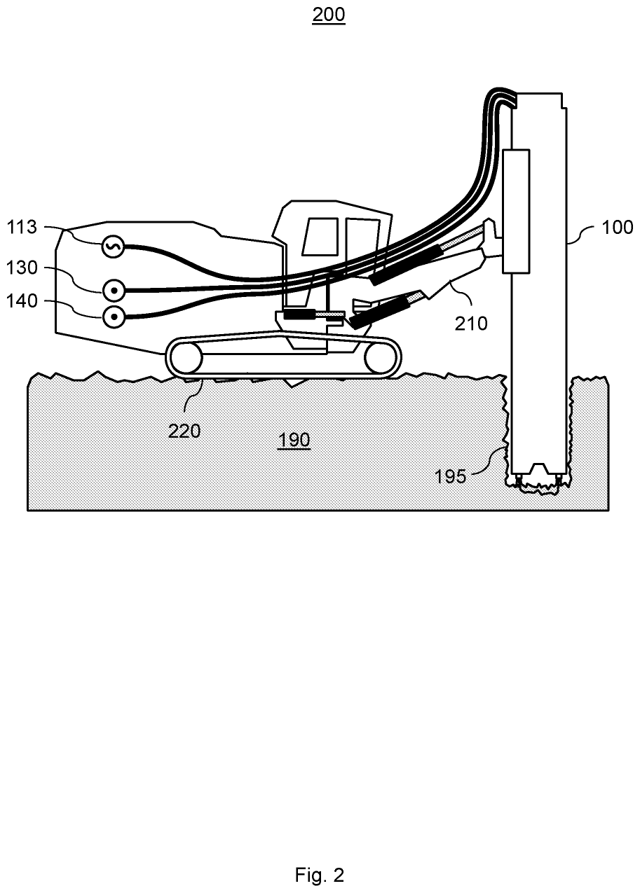

FIG. 2 schematically illustrates a rock drilling machine 200 comprising a drilling arrangement 100, as schematically illustrated in FIG. 1, drilling a hole 195 in a mineral substrate 190 in the form of a rock. As illustrated in FIG. 2, the drilling arrangement 100 may be several meters long. The rock drilling machine 200 may comprise an alternating current (AC) power supply 113 for powering the pulsed power generator 110. It may further comprise the fluid supply system 140, and preferably also a compressed gas supply system 130. A hydraulic, pneumatic, or electrically actuated arm 210 is preferably provided for at least vertical positioning of the drilling arrangement 100, such as in response to signals from one or more position sensors (not shown) or similar sensing the distance between the electrodes 180 and the mineral substrate surface. The rock drilling machine 200 preferably further comprises ground engaging members 220 for moving the rock drilling machine 200 in a direction parallel with a surface of the rock 190.

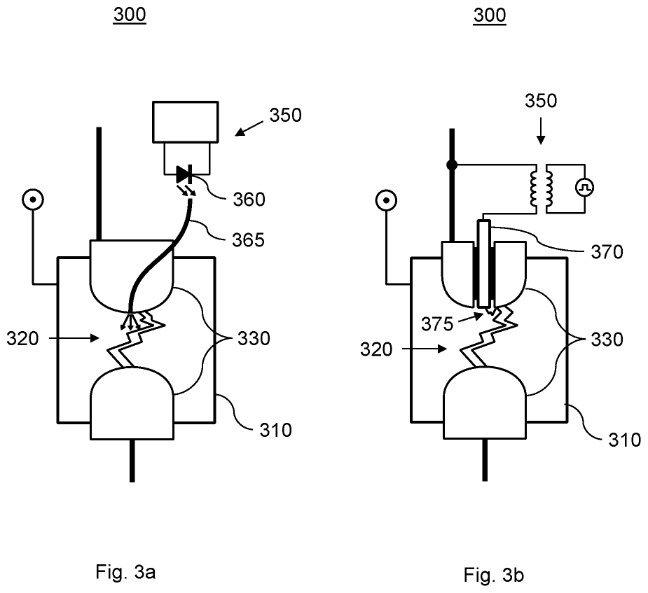

The pulsed power generator 110 is configured to generate pulses used for breaking the mineral substrate 190, such as nanosecond (ns) pulses, to the electrodes 180. The electrodes 180 are connectable to the pulsed power generator 110 by means of one or more controllable switches 300, which when they are closed allow the high voltage electro pulses from the pulsed power generator 110 to reach the electrodes 180. Each controllable switch 300 typically comprises a switch closing arrangement 350, such as illustrated in FIGS. 3a-b, which is controlled by receiving a switch trigger signal emitted from a switch control device 160 to close the switch 300. The switch control device 160 may be arranged to synchronize the switch trigger signal with the high voltage electro pulses from the pulsed power generator 110, or to control the timing of the closing of the switch 300 based on other parameters, e.g., relating to the properties of the mineral substrate or the drilling operation.

The controllable switches 300 may thus be controlled, using a switch trigger signal, to be synchronized e.g., with the high voltage electro pulses from the pulsed power generator 110. As the controllable switches 300 are closed, the high voltage electro pulse passes between the electrodes 180, and the mineral substrate 190 is thereby broken.

The pulsed power generator 110 schematically illustrated in FIG. 1 comprises a pulse transformer 112 in the form of a bank of capacitors, connected to the alternating current (AC) power supply 113 via a transformer 111. Using the controllable switches 300, a short high voltage pulse may be generated, which is then transferred to the electrodes 180. However, a setup using a bank of capacitors is especially sensitive to parasitic discharge through the electrodes 180 during the charging of the capacitors, and thus some way to limit the parasitic discharge is desirable. The proposed controllable switches 300 is an efficient way of achieving a limitation of the parasitic discharge for the pulsed power generator 110, by allowing the pulsed power generator 100 to not be connected to the electrodes 180 during charging of the bank of capacitors. Since the purpose of the one or more controllable switches 300 is to limit the parasitic discharge through the electrodes 180 during charging of the capacitors in the pulse transformer 112, it is important that the one or more controllable switches 300 is not closed during charging. In such an embodiment, it is the closing of the one or more controllable switches 300 that creates the high voltage electro pulse, and thus no further synchronization is needed. However, it may in this embodiment be desirable to control the timing of the closing of the one or more controllable switches 300 based on parameters such as e.g., the charging status of the bank of capacitors, or parameters relating to e.g., the properties of the mineral substrate or the drilling operation.

Other embodiments of a pulsed power generator 110 may of course be used instead. If the pulsed power generator 110 generates pulses independently of the controllable switches 300, the switch control device 160 may be controlled to emit a switch trigger signal for each high voltage electro pulse generated by the pulsed power generator 110, but it may also be controlled to emit a switch trigger signal only for e.g., every other or every third or fourth high voltage electro pulse generated by the pulsed power generator 110. Thus, the switch 300 does not necessarily have to be closed for each high voltage electro pulse generated by the pulsed power generator 110—this only affects the frequency of the high voltage electro pulses reaching the electrodes 180. The synchronization of the switch trigger signal with the high voltage electro pulses from the pulsed power generator 110 ensures that the high voltage electro pulses generated by the pulsed power generator 100 are conveyed to the electrodes 180 with an optimal pulse shape. The switch control device 160 is preferably controlled to emit the switch trigger signal with a predefined timing in relation to the high voltage electro pulse generated by the pulsed power generator 110.

The one or more controllable switches 300 may be any type of switches 300 that comprise a switch closing arrangement 350 which can be controlled by a switch trigger signal from a switch control device 160. FIGS. 3a-b schematically illustrate two different embodiments of such controllable switches 300. In both the schematically illustrated embodiments, the switch 300 comprises a pressurized volume 310 filled with a switch gas, in which pressurized volume 310 first and second switch electrodes 330 are arranged. The switch gas between the first and second switch electrodes 330 creates a spark gap 320. In both the schematically illustrated embodiments, there is also a switch closing arrangement 350 which causes the ionization of the switch gas in the pressurized volume 310, and thereby the closing of the switch 300. Both the schematically illustrated switches 300 thus comprise a spark gap 320 filled with a switch gas between switch electrodes 330, where a switch closing arrangement 350 causes the ionization of the switch gas, and thereby the closing of the switch 300. This is a reliable way of arranging a switch 300, compared to mechanical solutions, which may be unreliable at high voltages. Suitable gases which may be used as switch gases are e.g., nitrogen, or regular air. If very short high voltage electro pulses are desirable, SF6 may be used as the switch gas.

FIG. 3a schematically illustrates an ultraviolet (UV) triggered switch 300. The switch closing arrangement 350 may in this embodiment e.g., comprise a light emitting device 360, such as a laser or an UV led, and an optic guide 365 which guides the UV light emitted from the light emitting device 360 to the pressurized volume 310. When the UV light reaches the switch gas in the pressurized volume 310, the switch gas is ionized, which causes the spark gap between the first and second switch electrodes 330, and thereby the switch 300, to close. The switch trigger signal from the switch control device 160 in this embodiment causes the light emitting device 360 to generate light. This is a simple switch closing arrangement 350 that still allows an exact control of the closing of the switch 300, since the light emitting device 360 may be galvanically separated from the switch electrodes 330.

FIG. 3b schematically illustrates a high voltage (HV) triggered switch 300. The switch closing arrangement 350 may in this embodiment e.g., comprise an ignition electrode 370, which is arranged with a distance to one of the switch electrodes 330 that is much smaller than the distance between the switch electrodes 330. This creates a small spark gap 375, here termed an “ignition spark gap”, between the ignition electrode 370 and the closest one of the switch electrodes 330. Since the distance between the ignition electrode 370 and the closest one of the switch electrodes 330 is much smaller (of the order of less than a millimeter) than the distance between the switch electrodes 330, the voltage required to ionize the ignition spark gap is small (200V-5000V), compared to the breakdown voltage of the spark gap (>50 kV). This allows for a very exact control of the switch, since the voltage required for ignition is low enough to be handled by common solid state components, such as e.g., thyristors. The thyristors can in turn be triggered using the logic circuits of a microcomputer. The voltage may e.g., be supplied to a circuit using a separation transformer or wireless power transmission techniques. The circuit may e.g., contain an optically controlled thyristor that forwards the small voltage to the ignition electrode 370. This causes the ignition spark gap 375 between the ignition electrode 370 and the closest one of the switch electrodes 330 to break down, as schematically illustrated in FIG. 3b, and the electrons and ions generated there to migrate into the main spark gap. These migrated charges will accelerate due to the large electric field in the main spark gap, cause avalanche ionization of the switch gas in the pressurized volume 310, and thereby cause the main spark gap between the first and second switch electrodes 330 to break down, and thus the switch 300 to close.

Other embodiments of controllable switches 300 may be used, including other embodiments of controllable switches 300 comprising a spark gap 320 filled with a switch gas between switch electrodes 330, where a switch closing arrangement 350 causes the ionization of the switch gas and thereby the closing of the switch 300. Such a controllable switch 300 may e.g., be a radioactive radiation triggered switch 300. The switch closing arrangement 350 may in this embodiment e.g., comprise a radioactive source, and a radiation guide which guides the radioactive radiation emitted from the radioactive source to the pressurized volume 310. When the radioactive radiation reaches the switch gas in the pressurized volume 310, the switch gas is ionized, which causes the spark gap between the first and second switch electrodes 330, and thereby the switch 300, to close. The switch trigger signal from the switch control device 160 in this embodiment causes the radioactive source to generate radioactive radiation. Such an embodiment of the switch closing arrangement 350 allows an exact control of the closing of the switch 300, since the radioactive source may be galvanically separated from the switch electrodes 330. This embodiment may be set up quite similarly to the UV triggered switch 300 of FIG. 3a.

The switch control device 160 may be arranged to synchronize the switch trigger signal with the high voltage electro pulses from the pulsed power generator 110 by using the switch trigger signal also for triggering the pulses from the pulsed power generator 110, in embodiments where the pulsed power generator 110 generates pulses independently of the controllable switches 300. The switch control device 160 may emit the switch trigger signal in response to signals received from an external control unit 170, such as e.g., a control unit of a rock drilling machine 200 in which the drilling arrangement 100 is provided. In this case, the signals from the external control unit 170 may be used also for triggering the pulses from the pulsed power generator 110.

The switch control device 160 may include a microprocessor, a microcontroller, a programmable digital signal processor or another programmable device. Thus, the switch control device 160 may comprise electronic circuits and connections (not shown) as well as processing circuitry (not shown) for communicating with different parts of the drilling arrangement 100 as well as with the external control unit 170. For example, the switch control device 160 may be configured for communicating with various sensors, devices, systems, and control units of the drilling arrangement 100. In the shown embodiment, the switch control device 160 controls the transformer 111 as well as the switches 300. Although not shown, the switch control device 160 may also be used for controlling the fluid supply system 140, and/or the compressed gas supply system 130. Alternatively, several separate control units may be provided.

The switch control device 160 may comprise modules in either hardware or software, or partially in hardware or software, and communicate using known transmission buses such a CAN-bus and/or wireless communication capabilities. The processing circuitry may be a general-purpose processor or a specific processor. The switch control device 160 may comprise a non-transitory memory for storing computer program code and data. Thus, the skilled person realizes that the switch control device 160 may be embodied by many different constructions.

The drill tool 120 may be any type of drill tool suitable for forming a drill hole by conveying high voltage electro pulses through mineral substrate 190. The drill tool 120 may use any combination of electrodes 180. The drilling arrangement 100 may comprise a plurality of electrode pairs arranged around a perimeter of the front end 121 of the drill tool 120. At a center of the drill tool 120, there may be outlet of a shielding fluid conduit running from the fluid supply system 140, but a variety of different configurations are possible.

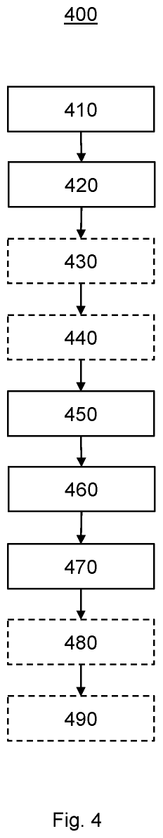

FIG. 4 schematically illustrates a method 400 for high voltage electro pulse rock drilling using a drilling arrangement 100 comprising a pulsed power generator 110, a drill tool 120 comprising electrodes 180, and a controllable switch 300, arranged between the pulsed power generator 110 and the electrodes 180, wherein the switch 300 when it is closed allows high voltage electro pulses from the pulsed power generator 110 to reach the electrodes 180. The method 400 may comprise:
Step 410: generating high voltage electro pulses, using the pulsed power generator 110.
Step 420: forming a drill hole 195 by conveying the generated high voltage electro pulses, via the electrodes 180, through mineral substrate 190 such as rock material.
Step 450: controlling the switch closing arrangement 350 to close the controllable switch 300.
Step 460: receiving a switch trigger signal emitted from a switch control device 160 in the switch closing arrangement 350.
Step 470: closing the controllable switch 300 based on the switch trigger signal.

This enables the achieving of a limitation of the parasitic discharge for the pulsed power generator 110, by allowing the pulsed power generator 110 to not always be connected to the electrodes 180.

The above steps may be effected in any order that makes technical sense, and some of the steps may be effected simultaneously with each other.

In embodiments, the pulsed power generator 110 comprises a pulse transformer 112 in the form of a bank of capacitors, and the generating 410 of the high voltage electro pulses comprises generating a high voltage electro pulse each time the switch 300 is closed. This is an efficient way of achieving a limitation of the parasitic discharge for the pulsed power generator 110, by allowing the pulsed power generator 100 to not be connected to the electrodes 180 during charging of the bank of capacitors.

In embodiments, the generating 410 of the high voltage electro pulses comprises continuously generating high voltage electro pulses, and the controlling 450 of the switch closing arrangement 350 comprises synchronizing the switch trigger signal with the generated high voltage electro pulses. This ensures that the high voltage electro pulses generated by the pulsed power generator 110 are conveyed to the electrodes 180 with an optimal pulse shape.

In embodiments, the drilling arrangement 100 comprises more than one switch 300. This enables the disconnection of both electrodes 180 from the pulsed power generator 110.

The method 400 may further comprise one or more of:
Step 430: controlling the switch control device 160 to emit a switch trigger signal for each high voltage electro pulse generated by the pulsed power generator 110. This enables every high voltage electro pulse generated by the pulsed power generator 110 to be conveyed to the electrodes 180.
Step 440: controlling the switch control device 160 to emit the switch trigger signal with a fixed timing in relation to the high voltage electro pulse generated by the pulsed power generator 110. This ensures that the high voltage electro pulses generated by the pulsed power generator 110 are conveyed to the electrodes 180, while still achieving a limitation of the parasitic discharge for the pulsed power generator.
Step 480: using the switch trigger signal also for triggering the pulses from the pulsed power generator 110, in order to synchronize the switch trigger signal with the high voltage electro pulses from the pulsed power generator 110. This is a simple way of synchronizing the switch trigger signal with the high voltage electro pulses from the pulsed power generator, which may e.g., be effected using a common control unit 170, in embodiments where the pulsed power generator 110 generates pulses independently of the controllable switches 300.
Step 490: for a switch 300 comprising a spark gap 320 filled with a switch gas between switch electrodes 330, causing the ionization of the switch gas, and thereby the closing of the switch 300, using the switch closing arrangement 350. This is a reliable way of arranging a switch 300, compared to mechanical solutions, which may be unreliable at high voltages.

The causing 490 of the ionization of the switch gas may, if the switch closing arrangement 350 comprises a light emitting device 360, involve using the light emitting device 360 to emit light into the switch gas. This is a simple switch closing arrangement 350 that still allows an exact control of the closing of the switch 300, since the light emitting device 360 may be galvanically separated from the switch electrodes 330.

The causing 490 of the ionization of the switch gas may, if the switch closing arrangement 350 comprises a radioactive source, involve using the radioactive source to emit radioactive radiation into the switch gas. Such an embodiment of the switch closing arrangement 350 allows an exact control of the closing of the switch 300, since the radioactive source may be galvanically separated from the switch electrodes 330.

The causing 490 of the ionization of the switch gas may, if the switch closing arrangement 350 comprises an ignition electrode 370, arranged so that there is an ignition spark gap 375 between the ignition electrode 370 and one of the switch electrodes 330, where the ignition spark gap 375 is much smaller than the main spark gap 320 between the switch electrodes 330, involve applying a voltage to the ignition electrode 370, causing the ignition spark gap 375 to break down. This causes the electrons and ions generated in the ignition spark gap 375 to migrate into the main spark gap 320, where they will accelerate due to the large electric field in the main spark gap 320, cause avalanche ionization of the switch gas in the pressurized volume 310, and thereby cause the main spark gap 320 between the first and second switch electrodes 330 to break down. This allows for a very exact control of the closing of the switch 300, since the voltage required for ignition is low enough to be handled by common solid state components, such as e.g., thyristors

The above steps may be effected in any order that makes technical sense, and some of the steps may be effected simultaneously with each other.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Accordingly, the scope of the invention is defined only by the claims.

1. A drilling arrangement for high voltage electro pulse rock drilling, the drilling arrangement comprising:
a pulsed power generator for generating high voltage electro pulses;
a drill tool for forming a drill hole by conveying the generated high voltage electro pulses, via electrodes in the drill tool, through mineral substrate;
a switch, arranged between the pulsed power generator and the electrodes, wherein the switch when it is closed allows high voltage electro pulses from the pulsed power generator to reach the electrodes; and
a switch control device,
wherein the switch is a controllable switch comprising a switch closing arrangement, which is arranged to be controlled by receiving a switch trigger signal emitted from the switch control device to close the switch.

2. The drilling arrangement according to claim 1, wherein the pulsed power generator comprises a pulse transformer in the form of a bank of capacitors and is arranged to generate a high voltage electro pulse each time the switch is closed.

3. The drilling arrangement according to claim 1, wherein the pulsed power generator is arranged to continuously generate high voltage electro pulses, and the switch control device is arranged to synchronize the switch trigger signal with the high voltage electro pulses from the pulsed power generator.

4. The drilling arrangement according to claim 3, wherein the switch control device is arranged to synchronize the switch trigger signal with the high voltage electro pulses from the pulsed power generator by using the switch trigger signal also for triggering the pulses from the pulsed power generator.

5. The drilling arrangement according to claim 1, wherein the switch comprises a spark gap filled with a switch gas between switch electrodes, and the switch closing arrangement causes the ionization of the switch gas and thereby the closing of the switch.

6. The drilling arrangement according to claim 5, wherein the switch closing arrangement comprises a light emitting device, which causes the ionization of the switch gas by emitting light into the switch gas.

7. The drilling arrangement according to claim 5, wherein the switch closing arrangement comprises a radioactive source, which causes the ionization of the switch gas by emitting radioactive radiation into the switch gas.

8. The drilling arrangement according to claim 5, wherein the switch closing arrangement comprises an ignition electrode, arranged so that there is an ignition spark gap between the ignition electrode and one of the switch electrodes, where the ignition spark gap is much smaller than the spark gap between the switch electrodes, and the ionization of the switch gas is caused by a voltage being applied to the ignition electrode, causing the ignition spark gap to break down.

9. The drilling arrangement according to claim 1, comprising more than one switch.

10. A method for high voltage electro pulse rock drilling using a drilling arrangement comprising a pulsed power generator, a drill tool comprising electrodes, and a controllable switch, arranged between the pulsed power generator and the electrodes, wherein the switch when it is closed allows high voltage electro pulses from the pulsed power generator to reach the electrodes, the method comprising:
generating high voltage electro pulses, using the pulsed power generator;
forming a drill hole by conveying the generated high voltage electro pulses, via the electrodes, through mineral substrate; and
controlling a switch closing arrangement to close the controllable switch,
wherein the switch closing arrangement is controlled by:
receiving a switch trigger signal emitted from a switch control device; and
closing the controllable switch based on the switch trigger signal.

11. The method according to claim 10, wherein the pulsed power generator comprises a pulse transformer in the form of a bank of capacitors, and the generating of the high voltage electro pulses comprises generating a high voltage electro pulse each time the switch is closed.

12. The method according to claim 10, wherein the generating of the high voltage electro pulses comprises continuously generating high voltage electro pulses, and the controlling of the switch closing arrangement comprises synchronizing the switch trigger signal with the generated high voltage electro pulses.

13. The method according to claim 12, further comprising using the switch trigger signal also for triggering the pulses from the pulsed power generator, in order to synchronize the switch trigger signal with the high voltage electro pulses from the pulsed power generator.

14. The method according to claim 10, wherein the switch comprises a spark gap filled with a switch gas between switch electrodes, the method further comprising causing the ionization of the switch gas, and thereby the closing of the switch, using the switch closing arrangement.

15. The method according to claim 14, wherein the switch closing arrangement comprises a light emitting device, and the causing of the ionization of the switch gas involves using said light emitting device to emit light into the switch gas.

16. The method according to claim 14, wherein the switch closing arrangement comprises a radioactive source, and the causing of the ionization of the switch gas involves using said radioactive source to emit radioactive radiation into the switch gas.

17. The method according to claim 14, wherein the switch closing arrangement comprises an ignition electrode, arranged so that there is an ignition spark gap between the ignition electrode and one of the switch electrodes, where the ignition spark gap is much smaller than the spark gap between the switch electrodes, and the causing of the ionization of the switch gas involves applying a voltage to the ignition electrode, causing the ignition spark gap to close.

18. The method according to claim 10, wherein the drilling arrangement comprises more than one switch.

19. (canceled)

20. A rock drilling machine comprising a drilling arrangement according to claim 1.
